(19) United States
(12) Patent Application Publication
(10) Pub. No.: US 2014/0029255 A1
(43) Pub. Date: Jan. 30, 2014

(54) COOLING SYSTEM AND LIGHTING DEVICE COMPRISED THEREOF

(71) Applicant: GE Lighting Solutions, LLC, East Cleveland, OH (US)

(72) Inventor: Tianci ZHOU, Shanghai (CN)

(21) Appl. No.: 13/933,359

(22) Filed: Jul. 2, 2013

(30) Foreign Application Priority Data
Jul. 26, 2012 (CN) 201210260962.1

(51) Int. Cl. F21V 29/02

(52) U.S. Cl. CPC F21V 29/02
USPC 362/235; 362/382

(57) ABSTRACT

Embodiments of a lighting device comprise cooling features that provide active cooling for dissipating heat by expelling air at the peripheral edge of the lighting device. In one embodiment, the cooling features include a heat sink element and an air moving device. The heat sink element comprises fin members disposed about a central axis. The fin members form peripheral channels that terminate at peripheral openings at the peripheral edge of the lighting device. During operation of the air moving device, air flows into and out of the peripheral openings to create a flow pattern with an inlet flow and an outlet flow. In one example, the inlet flow and the outlet flow correspond to groupings of the fin members, wherein the groupings dictate the direction of flow of air into and out of the lighting device.

### BACKGROUND

1. Technical Field

The subject matter of the present disclosure relates to the illumination arts, lighting arts, solid-state lighting arts, and related arts.

2. Description of Related Art

In the field of lighting, solid state devices (e.g., light emitting diode (LED) devices) and other highly efficient light emitting devices are becoming more and more popular because they present many advantages including lower energy consumption, longer lifetime, faster switching, and greater durability and reliance. Although many lighting devices still adopt conventional technology, e.g., incandescent lights and bulbs, as their light sources, there are already many lighting devices using solid state devices instead of conventional light sources to avoid disadvantages, e.g., short lifetime, low light emitting efficiency, and sometimes environmentally unfriendly operation.

As one example, solid-state lighting technologies such as LEDs and LED devices often have performance that is superior to incandescent lamps. This performance can be quantified by its useful lifetime (e.g., its lumen maintenance and its reliability over time). For example, whereas the lifetime of incandescent lamps is typically in the range about 1000 to 5000 hours, lighting devices that use LED devices are capable of operation in excess of 25,000 hours, and perhaps as much as 100,000 hours or more.

A challenge with solid-state technology is the need to adequately dissipate heat. LED devices are highly temperature-sensitive in both performance and reliability as compared with incandescent or other conventional technology (e.g., halogen filaments). To address these features, known lighting devices will place a heat sink in contact with or in thermal contact with the LED device. Such passive cooling systems, however, often do not provide adequate dissipation of thermal energy and, in some cases, may block light that the LED device emits. Moreover, use of fans and similar air moving devices to promote active cooling may not fit within the physical constraints such as regulatory limits that define maximum dimensions for the resulting lighting devices.

### BRIEF DESCRIPTION OF THE INVENTION

This disclosure describes, in one embodiment, a lighting device that comprises an air moving device and a heat sink element. The heat sink element comprises a plurality of fin members disposed about a central axis and forming a cavity to receive the air moving device therein. The plurality of fin members form peripheral channels terminating at peripheral openings on the peripheral edge of the heat sink element. In one example, the fin members are arranged in an inlet grouping through which air flows into the lighting device and an outlet grouping through which air flows out of the lighting device and which is angularly offset about the central axis relative to the inlet grouping.

This disclosure also describes, in one embodiment, a lighting device that comprises a heat sink element with a central axis and having fin members forming peripheral channels that terminate at peripheral openings disposed about the central axis and at the peripheral edge of the heat sink element. The lighting device also comprises a light source in position on a first side of the heat sink element and an air moving device in position on a second side of the heat sink element and aligned with the central axis. In one example, the fin members are arranged in an inlet grouping and an outlet grouping that is angularly offset from the inlet grouping about the central axis. During operation of the air moving device, air flows into the lighting device via the peripheral openings in the inlet grouping and out of the lighting device via the peripheral openings in the outlet grouping.

This disclosure further describes, in one embodiment, a lighting device that comprises a light source and a cooling system in thermal contact with the light source. The cooling system comprises peripheral openings disposed at the peripheral edge of the lighting device, the peripheral openings arranged as part of an inlet grouping and an outlet grouping that is angularly offset from the inlet grouping. In one example, the cooling system can generate a flow pattern in which air flows into the lighting device via the peripheral openings in the inlet grouping and out of the lighting device via the peripheral openings in the outlet grouping.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1 depicts a perspective view of an exemplary lighting device;

FIG. 2 depicts an exemplary fluid flow pattern in the exemplary lighting device of FIG. 1;

FIG. 3 depicts a schematic diagram that illustrates a bottom view of an exemplary lighting device that distributes air according to the fluid flow pattern of FIG. 2;

FIG. 4 depicts a cross-section view of the exemplary lighting device of FIG. 1;

FIG. 5 depicts a perspective view of a cooling system for use in the exemplary lighting device of FIG. 1; and

FIG. 6 depicts a top view of the cooling system of FIG. 5.

Like reference characters designate identical or corresponding components and units throughout the several views, which are not to scale unless otherwise indicated.

### DETAILED DESCRIPTION OF THE INVENTION

Broadly, the embodiments of the lighting devices below incorporate an active cooling solution to dissipate heat from the lighting device. These embodiments deploy an air moving device to create a flow pattern in which air enters and exits the lighting device. The resulting flow pattern, however, occurs at the peripheral edge of the lighting device. This flow pattern can improve cooling efficiency and efficacy because the distribution of air at the periphery and/or the peripheral edge prevents re- circulation of heated air back into the lighting device with air drawn into the lighting device. This feature ensures ingress of cooler air into the lighting device to promote convection and, ultimately, to help dissipate more thermal energy from inside of the lighting device out to the surrounding environment.

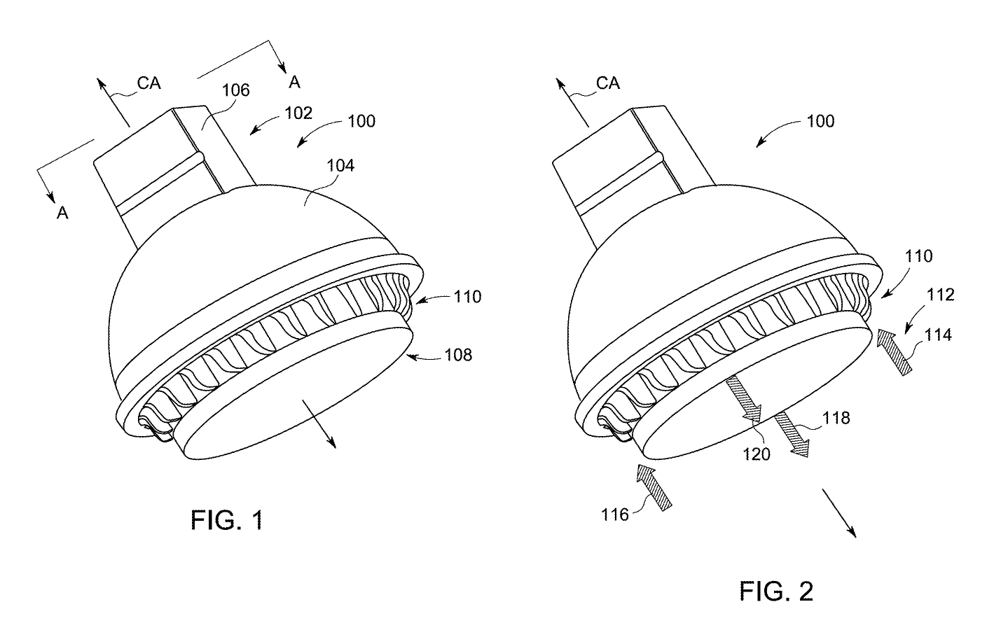

FIG. 1 depicts an exemplary lighting device 100 with cooling features to dissipate thermal energy from inside of the lighting device 100 to the surrounding environment. The lighting device 100 is applicable to a variety of commercial and consumer applications, e.g., commercial retail and hospitality lighting applications as accent lighting. In one embodiment, the lighting device 100 has a form factor consistent with so-called multi-faceted reflector (MR) lamps and illumination products. However, the cooling features the present disclosure describes below can apply to any number of form factors (e.g., parabolic aluminized reflector (PAR) lamps) and industry standard designs for lighting devices.

The lighting device 100 has a central axis CA and includes a housing 102 with a cover element 104 and a connector element 106. A lens element 108 diffuses light, e.g., to form a light beam or other illumination pattern that exits the housing 102. As discussed more below, the lighting device 100 has inlet and outlet features that circumscribe the peripheral edge 110 of the lighting device 100. Examples of the lighting device cause air to flow into and out of the housing 102 at various locations about the peripheral edge 110 to effectively dissipate heat that arises, e.g., from the light source of the lighting device 100. The position of the inlet and outlet features on the peripheral edge 110 improves cooling efficiency and efficacy by, in one example, creating a flow pattern that reduces re-circulation of heated air the lighting device 100 expels during operation.

FIG. 2 illustrates an exemplary flow pattern 112 that occurs along the peripheral edge 110 during operation of the lighting device 100. The flow pattern 112 includes an inlet flow (e.g., a first inlet flow 114 and a second inlet flow 116) and an outlet flow (e.g., a first outlet flow 118 and a second outlet flow 120). In one example, the inlet flow 114, 116 and the outlet flow 118, 120 are parallel to the central axis CA and, moreover, can be parallel to one another. The inlet flow 114, 116 and the outlet flow 118, 120 are located and correspond to inlet and outlet features at which air can, respectively, enter and exit the housing 102. This disclosure, however, contemplates other configurations for the flow pattern 112, where one or more of the inlet flow 114, 116 and the outlet flow 118, 120 incorporate more or less locations for air to flow into and out of the housing 102 than those necessarily shown in FIG. 2 or throughout this disclosure.

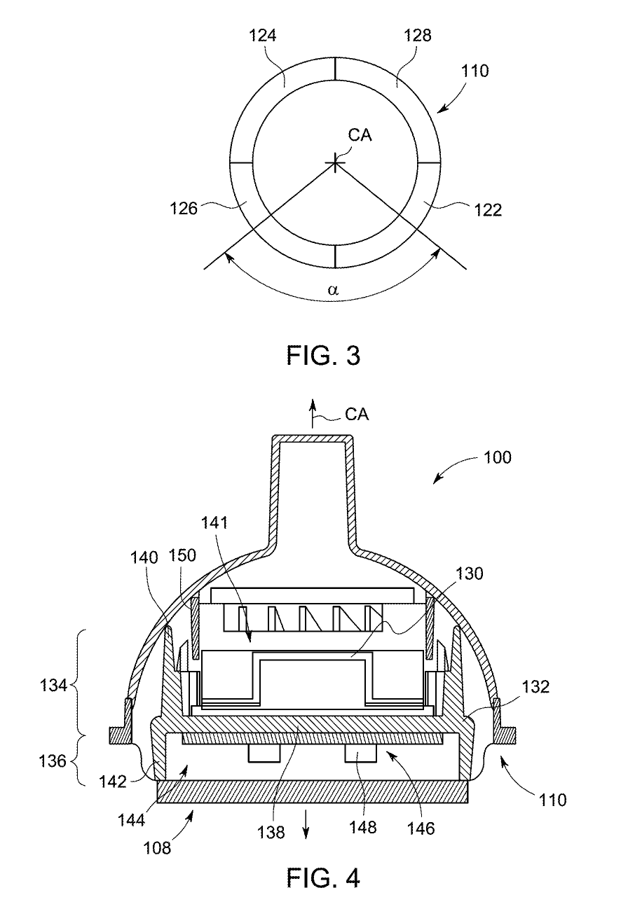

Examples of inlet and outlet features can cover particular radial sections (examples of which are found in FIG. 3) on the peripheral edge 110. In one example, the radial sections for the inlet flow 114, 116 are on opposing sides of the housing 102 and the radial sections for the outlet flow 118, 120 are also on opposing sides of the housing 102. This configuration of inlet and outlet features separates the inlet flow 114, 116 from the outlet flow 118, 120. Such separation reduces the likelihood that warm, heated air that flows out of the housing 102, e.g., via the outlet airflow 118, 120, will mix with and/or re-circulate back into the housing 102, e.g., via the inlet flow 114, 116, which would limit the effective heat dissipation from the lighting device 100.

FIG. 3 shows one configuration for the radial sections along the peripheral edge 110. In this example, the radial sections include inlet sections (e.g., a first inlet section 122 and a second inlet section 124) and outlet sections (e.g., a first outlet section 126 and a second outlet section 128). The radial sections for the inlet airflow 114, 116 and the outlet airflow 118, 120 are angularly offset from one another about the central axis CA, as generally indicated by the character a. As shown in FIG. 3, the angular offset a can be about 90°, e.g., as measured from the middle of the radial section for the first inlet section 122 to the middle of the radial section for the first outlet section 126. The angular offset a can be less than 90°, to accommodate more radial sections for the inlet flow 114, 116 (FIG. 2) and/or the outlet flow 118, 120 (FIG. 2).

The inlet sections 122, 124 and the outlet sections 126, 128 may comprise equal portions of the peripheral edge 110. In the examples of FIG. 3, the radial sections are equally distributed about the peripheral edge 110. In other examples, one or more of the radial sections can take up more or less of the peripheral edge 110 relative to the other sections. The extent to which the inlet sections 122, 124 and the outlet sections 126, 128 cover the peripheral edge 110 (also the “radial size” of the respective sections) may depend on, for example, optimal flow characteristics for one or more of the inlet flow and the outlet flow as well as on optimal heat dissipation characteristics for cooling the lighting device 100.

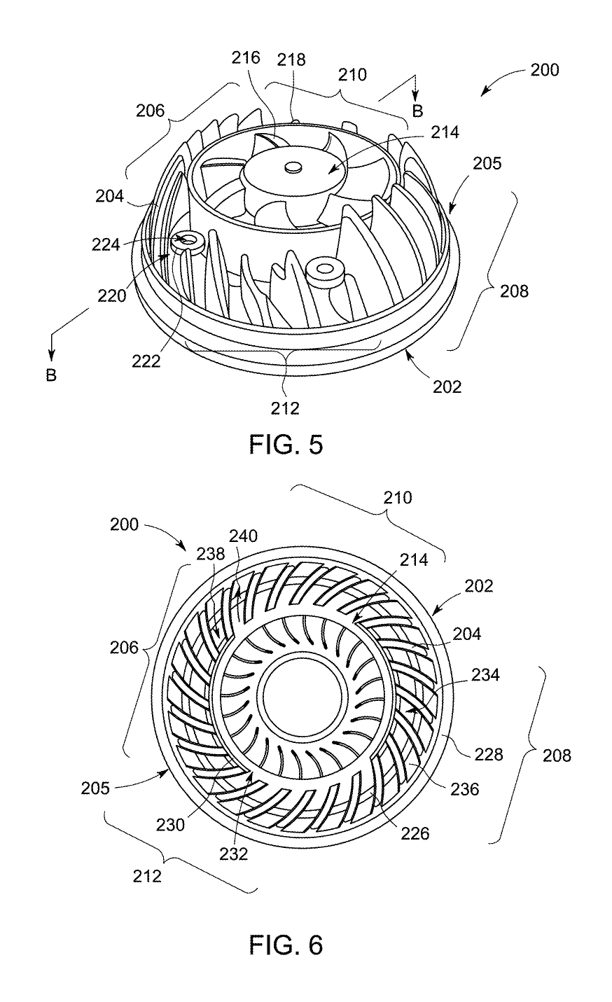

FIG. 4 depicts a cross-section of the lighting device 100 taken along a plane generally identified by A-A in FIG. 1 to illustrate one example of cooling features for the lighting device 100. The cooling features include an air moving element 130 aligned on the central axis CA and a heat sink element 132 with a first side 134 and a second side 136. On the first side 134, the heat sink element 132 includes a web member 138 and a plurality of fin members 140 arranged about the central axis CA. The web member 138 and the fin members 140 form a first cavity 141 of diameter sufficient to allow the air moving element 130 to fit therein. As best shown in FIGS. 5 and 6 and discussed below, the fins members 140 form channels (e.g., channels 234 of FIG. 6), which separate adjacent fins members 140 from one another. Air can flow through the channels toward the peripheral edge 110 of the lighting device 100, e.g., to generate the outlet flow 118, 120.

On the second side 136, the heat sink 132 can have a lip or protruding element, which in the illustration of FIG. 4 comprises a peripheral wall 142 that extends in a generally downward direction relative to the heat sink element 132. The peripheral wall 142 terminates at a surface or other feature, which can receive and secure the lens element 108. In one example, the peripheral wall 142 is also spaced apart from the central axis CA to form a second cavity 144 with the web member 138.

A light source 146 resides in the second cavity 144. The light source 146 can have one or more light emitting devices 148 as the primary light source. Examples of the light emitting devices 148 can include light emitting diodes (LEDs) as well as other types of light-emitting devices, e.g., incandescent devices that use incandescent filaments, halogen devices that use a halogen capsule, fluorescent devices that use a fluorescent tube, high intensity discharge (HID) devices, and combinations thereof. The light-emitting devices 148 can also encompass organic and inorganic light-emitting diodes (LED) devices of various constructions. These LED devices can comprise bare semiconductor chips, encapsulated semiconductor chips, as well as various configurations of chip packages in which the LED device is mounted on one or more intermediate elements such as a sub-mount, a lead-frame, a surface mount support. In one example, the LED device can incorporate a reflective member in the form of a cup, dome, cylinder, and/or other shape to direct light, e.g., away from the light source 148 toward the lens element 108. In still other examples, the LEDs can comprise a coating or other material layer, e.g., a wavelength-converting phosphor coating with or without an encapsulant.

The heat sink element 132 can be formed monolithically as a single, integrated component (e.g., with the web member 138, the fin members 140, and the protruding element 142 integrated together). Such construction may lend itself to certain manufacturing techniques, e.g., techniques to cast and/or mold the heat sink element 132. In other constructions, the heat sink element 132 may comprise an assortment of separate pieces that are assembled and secured together using one or more known fasteners, e.g., screws, bolts, and adhesives.

As discussed above, in one aspect, construction of the lighting device 100 facilitates transfer of thermal energy from the light source 146 and out of the lighting device 100. For example, the heat sink element 132 can comprise materials and/or components with properties to conduct and dissipate thermal energy and, in particular, thermal energy on the scale the light source 148 can generate. These materials can include metals, plastics, and composites having a thermal conductivity from about 1 W/(m-K) to 2000 W/(m-K). As shown in FIG. 4, the light source 146 can mount in the second cavity 144 against and/or in thermal contact with the web member 138. Direct and/or partial contact between these elements permits thermal energy to flow from the light source 146 into the heat sink element 132 through conduction.

During operation, the air moving device 130 generates a flow of air that travels through the channels between the fin members 140 toward the periphery of the lighting device 100. This flow contacts the surface of the fin members 140, thereby generating convective dissipation of thermal energy from the heat sink element 132 into the moving air. The heated air exhausts to the periphery of the lighting device 100 as the outlet flow 118, 120. The web member 138 prevents air from flowing downward, e.g., into the second cavity 144. In one embodiment, the lighting device 100 can include an additional air diverting member in the form of, for example, a cylindrical sleeve 150 that mates with the heat sink element 132, e.g., to the fin members 140. The cylindrical sleeve 150 is useful to direct air towards the peripheral edge 110, where the air is expelled from the lighting device 100.

FIG. 5 illustrates an example of a cooling system 200, e.g., for use in the lighting device 100 of FIGS. 1, 2, 3, and 4. The cooling system 200 includes a heat sink element 202 with one or more fin members 204 disposed about a peripheral edge 205. The fins members 204 are arranged in one or more inlet groupings (e.g., a first inlet grouping 206 and a second inlet grouping 208) and one or more outlet groupings (e.g., a first outlet grouping 210 and a second outlet grouping 212). The inlet groupings 206, 208 and the outlet groupings 210, 212 form radial sections (e.g., radial sections 122, 124, 126, 128 of FIG. 3), which would be located about the peripheral edge 205 of a lighting device (e.g., lighting device 100). A fan unit 214 resides in a cavity formed in the center of the fins members 204. The fan unit 214 includes one or more fan blades 216 and a housing 218 with attachment elements 220 to secure the fan unit 214 to the heat sink 202. In one example, the attachment elements 220 take the form of a boss 222 with an opening 224 to receive a fastener (e.g., a screw and/or bolt). Moreover, although shown coupled with the heat sink element 202, in other configurations the fan unit 214 can mount to other features of the lighting device. For example, the fan unit 214 can be suspended in the assembly by spokes or protrusions, e.g., protrusions that extend from the housing 102 of FIG. 1.

Construction of the fin members 204, e.g., the shape, contour, and/or other features, can facilitate both dissipation of thermal energy and air flow. In one example, it may be advantageous to construct the fin members 204 to have the largest available surface area for conduction and/or convection of thermal energy. As shown in FIG. 5, the fin members 204 in the inlet groupings 206, 208 can work in combination with other features (e.g., wall member 150 of FIG. 4) to prevent warm, heated air from reflowing into the inlet flow of the fan unit 214. This feature can help to direct air towards the outlet groupings 210, 212 and, ultimately, out of the lighting device altogether.

FIG. 6 depicts a top view of the cooling system 200 in a direction generally identified by line B-B of FIG. 5. In one construction, the heat sink element 202 includes one or more members (e.g., an inner member 226 and an outer member 228). The fin members 204 secure the members 226, 228 to one another. A wall member 230 couples the fin members 204 of the first inlet grouping 206 and the second inlet grouping 208. The wall member 230 forms part of an inner bore 232 in which the fan unit 214 resides.

Construction of the heat sink element 202 forms, in one example, a peripheral channel 234 between adjacent fin members 204 that circumscribe the peripheral edge of the heat sink element 202. The peripheral channel 234 terminates at a peripheral opening 236 that exposes the peripheral channel 234 to the surrounding environment. Air flows into and out of the heat sink element 202 via the peripheral openings 236, as generally shown by the arrow 238 (also “inlet air 238) and the arrow 240 (also the “outlet air 240”). In one implementation, during operation of the fan unit 214, inlet air 238 flows into the peripheral openings 232 and traverses the peripheral channels 234 in the inlet groupings 206 and 208. The inlet air 238 circulates throughout the heat sink element 202, e.g., throughout the bore 232. Operation of the fan unit 214 directs the inlet air 238 to the peripheral channels 234 in the outlet groupings 210, 212, where the outlet air 240 flows out of the peripheral openings 232.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose embodiments of the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A lighting device, comprising:
an air moving device; and
a heat sink element comprising a plurality of fin members disposed about a central axis and forming a cavity to receive the air moving device therein, the plurality of fin members forming peripheral channels terminating at peripheral openings on the peripheral edge of the heat sink element, wherein the fin members are arranged in an inlet grouping through which air flows into the lighting device and an outlet grouping through which air flows out of the lighting device and which is angularly offset about the central axis relative to the inlet grouping.

2. The lighting device of claim 1, wherein the heat sink member comprises a wall member that couples the fin members in the inlet grouping together to form a portion of the cavity.

3. The lighting device of claim 2, wherein the air moving device comprises an air moving element aligned on the central axis and disposed in the cavity.

4. The lighting device of claim 1, further comprising a light source in thermal contact with a web member of the heat sink element.

5. The lighting device of claim 5, wherein the light source comprises one or more light emitting diodes.

6. The lighting device of claim 1, wherein the inlet grouping includes a first inlet grouping and a second inlet grouping forming radial sections on opposing sides of the heat sink element and the outlet grouping includes a first outlet grouping and a second outlet grouping forming radial sections on opposing sides of the heat sink element and angularly offset from the radial sections of the inlet grouping.

7. The lighting device of claim 6, wherein the radial sections are equally distributed on the periphery of the heat sink element.

8. The lighting device of claim 1, further comprising a cover element enclosing the air moving device and mating with the heat sink element to permit air to flow into and out of peripheral openings.

9. The lighting device of claim 1, wherein the heat sink element comprises an inner member and an outer member, and wherein the fin members secure the inner member to the outer member.

10. The lighting device of claim 1, wherein the lighting device has a form factor consistent with a multi-faceted reflector (MR) lamp.

11. A lighting device, comprising:
a heat sink element with a central axis and having fin members forming peripheral channels that terminate at peripheral openings disposed about the central axis and at the peripheral edge of the heat sink element;
a light source in position on a first side of the heat sink element; and
an air moving device in position on a second side of the heat sink element and aligned with the central axis,
wherein the fin members are arranged in an inlet grouping and an outlet grouping that is angularly offset from the inlet grouping about the central axis, and
wherein, during operation of the air moving device, air flows into the lighting device via the peripheral openings in the inlet grouping and out of the lighting device via the peripheral openings in the outlet grouping.

12. The lighting device of claim 11, wherein the inlet grouping and the outlet grouping form a flow pattern with an inlet flow and an outlet flow that are parallel to the central axis.

13. The lighting device of claim 11, wherein the heat sink element comprises a wall member that couples the fin members in the inlet grouping together to form a portion of a cavity, and wherein the air moving device is disposed in the cavity.

14. The lighting device of claim 11, wherein the heat sink element comprises materials to conduct heat from the light source.

15. The lighting device of claim 11, wherein the heat sink element comprises a cylindrical sleeve that directs air into the peripheral channels.

16. A lighting device, comprising:
a light source; and
a cooling system in thermal contact with the light source, the cooling system comprising peripheral openings disposed at the peripheral edge of the lighting device, the peripheral openings arranged as part of an inlet grouping and an outlet grouping that is angularly offset from the inlet grouping,
wherein the cooling system can generate a flow pattern in which air flows into the lighting device via the peripheral openings in the inlet grouping and out of the lighting device via the peripheral openings in the outlet grouping.

17. The lighting device of claim 16, wherein the light source comprises one or more light emitting diodes.

18. The lighting device of claim 16, wherein the cooling system comprises an air moving device, and wherein operation of the air moving device causes a flow pattern through the peripheral openings with an inlet flow and an outlet flow that are parallel to the central axis.

19. The lighting device of claim 16, wherein the cooling system comprises a plurality of fin members disposed about the central axis, and wherein the fin members form peripheral channels that terminate at the peripheral openings.

20. The lighting device of claim 19, wherein the cooling system comprises an air moving element aligned on the central axis and in a cavity bounded by a wall member that couples the fin members in the inlet grouping together.
